(19) United States
(12) Patent Application Publication
(10) Pub. No.: US 2014/0212227 A1
(43) Pub. Date: Jul. 31, 2014

(54) TWO SIDED MILLING TOOL CUTTER INSERT AND HOLDER

(71) Applicant: Michael Bitner, Bloomfield, CT (US)

(72) Inventor: Michael Bitner, Bloomfield, CT (US)

(21) Appl. No.: 13/836,935

(22) Filed: Mar. 15, 2013

Related U.S. Application Data
(60) Provisional application No. 61/756,793, filed on Jan. 25, 2013.

(51) Int. Cl. B23C 5/10; B23C 5/22; B23C 5/20

(52) U.S. Cl. CPC B23C 5/1027; B23C 5/207; B23C 5/2247
USPC 407/40; 407/113; 407/34; 409/131

(57) ABSTRACT

A milling tool includes a reversible cutter insert with a central opening having two pairs of cutting surfaces and edges. A pair of planar locating shoulders are disposed on each side of the insert, and each shoulder extends between the insert side face and an adjacent one of the cutting surfaces. The plane of each locating shoulder is at an angle to and intersects the longitudinal axis of the insert central opening. A cutter holder has a slot receiving the cutter insert with a pair of planar locating surfaces oriented at the same angle as the insert locating shoulder plane. The holder locating surfaces are abutted with and contact the insert locating shoulders to support the insert and permit one of the pair of insert cutting surfaces and edges extending out of the slot to cut a workpiece.

### BACKGROUND OF THE INVENTION

1. Field of the Invention

This application relates to tools used for machining metals and other materials and in particular to a two-sided ball milling tool cutter insert that is reversible in the holder body.

2. Description of Related Art

Metalcutting shops throughout manufacturing use various different types of cutting tools in the manufacture of different molds, dies and production/prototype components. Milling tools may be used to create complex surfaces, for example, tapered pockets or walls, such as those used in molds. A backdraft insert held in a tool body or holder is typically employed for such applications. In the more complex parts, three-dimensional machining (simultaneous 3-axis movement) is sometimes utilized to create a tapered or flowing (non-flat) surface. For these more complex parts, a specific type of cutter insert, typically referred to as a ball nose end mill, is typically used. Such milling tool inserts are provided in various forms for roughing or finishing, and made from various alloys such as high-speed steel and solid carbide. Typical cutter inserts are good for only a single-use, with each insert being either discarded or in rare cases re-sharpened after use. Two-sided, reversible cutter inserts have been suggested, such as those disclosed in U.S. Pat. Nos. 5,064,316 and 6,575,670, but these have required complex insert and holder designs.

### SUMMARY OF THE INVENTION

Bearing in mind the problems and deficiencies of the prior art, it is therefore an object of the present invention to provide an improved milling tool that may use reversible cutter inserts.

It is another object of the present invention to provide a milling tool that has a cutter insert holder of high strength to secure reversible cutter inserts.

A further object of the invention is to provide a milling tool that has a cutter insert holder that does not require multiple components to secure a reversible cutter insert.

It is yet another object of the present invention to provide a milling tool that that does not require complex design of a cutter insert that is reversible within the cutter holder.

Still other objects and advantages of the invention will in part be obvious and will in part be apparent from the specification.

The above and other objects, which will be apparent to those skilled in the art, are achieved in the present invention which is directed to a milling tool comprising a reversible cutter insert having two opposite parallel planar side faces having a central opening. The central opening has a longitudinal axis passing between the side faces in a direction normal to the planes thereof. The cutter insert has an axis of rotation extending between the side faces in a direction normal to the central opening axis. First and second pairs of cutting surfaces are disposed at opposite ends of the insert along the rotational axis. Each of the pairs of cutting surfaces have a cutting edge adjacent a cutting surface, with one cutting edge in each pair of cutting surfaces being on an opposite side of the cutter axis and facing in a direction opposite the other cutting edge in the pair. Each pair of cutting surfaces and adjacent cutting edges are capable of cutting a workpiece upon rotation of the cutter insert about the insert rotational axis. A pair of planar locating shoulders are disposed on each side of the insert, with one shoulder of a pair on one side of the central opening and the other shoulder of a pair on the other side of the central opening. Each shoulder extends between the side face and an adjacent one of the cutting surfaces. The plane of each locating shoulder is at an angle to and intersects the longitudinal axis of the insert central opening.

The insert cutting surfaces and adjacent cutting edges may be disposed in a plane containing the insert rotational axis.

The milling tool further includes a cutter holder rotatable about an axis, the cutter holder having a slot at one thereof containing the holder axis. The holder slot receives the insert with the insert rotational axis aligned with the holder rotational axis. The slot has opposite parallel planar inside faces contacting the insert side faces. The slot inside faces each have an opening aligned with the insert central opening for receiving a removable fastener to secure the insert within the slot. The first pair of insert cutting surfaces and edges extend out of the slot at the end of the holder and the second pair of insert cutting surfaces and edges are disposed substantially within the slot.

The holder slot further has a pair of planar locating surfaces, with one locating surface extending from one of the inside faces and the other locating surface extending from the other of the inside faces. The holder slot locating surfaces may be integral with the inside faces of the holder slot. The plane of each locating surface is at the same angle as the insert locating shoulder plane and intersects the longitudinal axis of the slot central openings. The pair of holder locating surfaces are abutted with and contact the insert locating shoulders adjacent the second pair of cutting surfaces to support the insert locating shoulder within the holder slot and permit the first pair of insert cutting surfaces and edges extending out of the slot to cut a workpiece when the milling tool is rotated about the rotational axis.

The cutter holder slot may further include a lower surface configured to conform to the shape of the second pair of insert cutting edges. Other insert cutting edge and slot lower surface configurations are possible. If different cutter insert sizes and shapes are to be used in the cutter holder, the slot lower surface may be configured to accept the largest of the different cutter insert shapes without interference.

The cutter insert is removable from the holder slot, rotatable 180° about the central opening axis to reverse the cutting surfaces and edges, and re-securable within the holder slot with the pair of holder locating surfaces being abutted with and contacting the insert locating shoulders adjacent the first pair of cutting surfaces to support the insert locating shoulder within the holder slot and permit the second pair of insert cutting surfaces and edges to extend out of the slot to cut a workpiece when the milling tool is rotated about the rotational axis.

In another aspect, the present invention is directed to a method of using a milling tool to cut a workpiece. The method initially includes providing the cutter insert and cutter holder as described above. The method then includes securing the cutter insert in the holder slot with the pair of holder locating surfaces being abutted with and contacting the insert locating shoulders adjacent the second pair of cutting surfaces so that the first pair of insert cutting surfaces and edges extend out of the slot. The method further includes rotating the milling tool about the rotational axis and cutting a workpiece with the first pair of cutting edges. Subsequently, the method includes removing the cutter insert from the holder slot, rotating the cutter insert 180° about the central opening axis, and securing the cutter insert in the holder slot with the pair of holder locating surfaces being abutted with and contacting the insert locating shoulders adjacent the first pair of cutting surfaces so that the second pair of insert cutting surfaces and edges extend out of the slot. The method then includes rotating the milling tool about the rotational axis and cutting a workpiece with the second pair of cutting edges.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a side elevational view of an embodiment of a milling tool of the present invention, showing a two-side spherical ball nose cutter insert mounted in a cutter body or holder.

FIG. 2 is an end elevational view of the milling tool of FIG. 1, showing the cutter insert mounted in a slot of the cutter holder.

FIG. 3 is a top plan view of the milling tool of FIG. 1, showing the cutter insert mounted in a slot of the cutter holder.

FIG. 4 is a vertical cross-sectional view of the milling tool of FIG. 1 along lines 4-4 of FIG. 2.

FIG. 5 is an angled cross sectional view of the milling tool of FIG. 1 along lines 5-5 of FIG. 1.

FIG. 6 is a top plan view of the milling tool of FIG. 1, showing the slot of the cutter holder, without the cutter insert.

FIG. 7 is a vertical cross-sectional view of the cutter holder in the milling tool of FIG. 1, without the cutter insert, along lines 7-7 of FIG. 1.

FIG. 8 is a vertical cross-sectional view of the cutter holder in the milling tool of FIG. 4, without the cutter insert.

FIG. 9 is an elevational side view of the cutter insert in the milling tool for FIG. 1, without the cutter holder.

FIG. 10 is an elevational view of the reverse side of the cutter insert of FIG. 9.

FIG. 11 is a top plan view of the cutter insert of FIG. 9.

FIG. 12 is a perspective view of the cutter insert of FIG. 9.

FIG. 13 is a perspective view of a double-sided backdraft cutter insert having another embodiment of the insert locating shoulders of the present invention.

FIG. 14 is a side elevational view of the cutter insert of FIG. 13.

### DESCRIPTION OF THE PREFERRED EMBODIMENT(S)

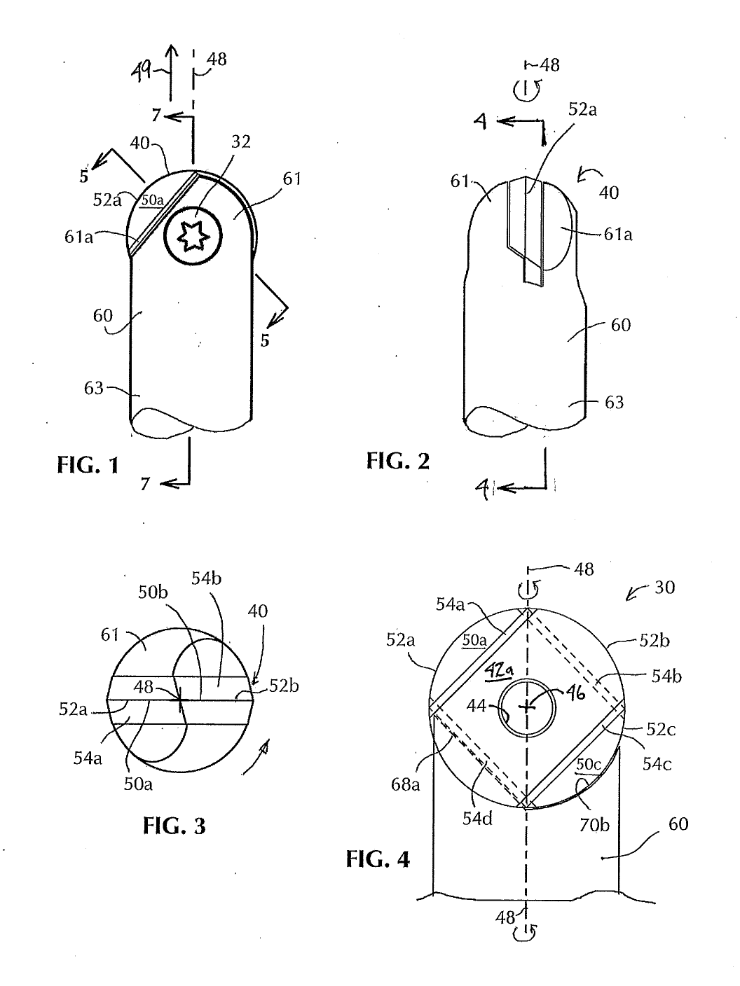

In describing the preferred embodiment of the present invention, reference will be made herein to FIGS. 1-14 of the drawings in which like numerals refer to like features of the invention.

The present invention is useful for any number of double-sided cutter inserts used in milling tools, for example spherical ball nose inserts and backdraft inserts. The double sided inserts provide two usable cutting edge pairs per insert.

One embodiment of the present invention is milling tool 30 shown in FIGS. 1-12. The milling tool includes a reversible cutter insert 40 which may be received within a pocket or slot 62 at end 61 of a elongated cylindrical cutter body or holder 60. The cutter insert and cutter holder revolve about an axis of rotation 48 when the holder is mounted at shank end 63 and used in an otherwise conventional milling machine (not shown). Cutting insert 40 is typically made of tungsten carbide and cutting holder 60 is typically made of alloy or tool steel, although other metals, alloys or materials may be used. The cutter insert example of FIGS. 1-12 is shown as a two-side spherical ball nose insert that may be used to form variously shaped tapered or flowing surfaces.

Cutter insert 40 is circular in side view and the body has two opposite parallel planar side faces 42a, 42b and a central opening 44 having a longitudinal axis 46. Insert opening 44 extends and passes between the side faces 42a, 42b in a direction normal to the planes of the faces. The cutter insert axis of rotation 48a extends between side faces 42a, 42b in a direction normal to central opening axis 46. Cutter insert 40 as shown has 180° rotational symmetry about axis 48a and about axis 46.

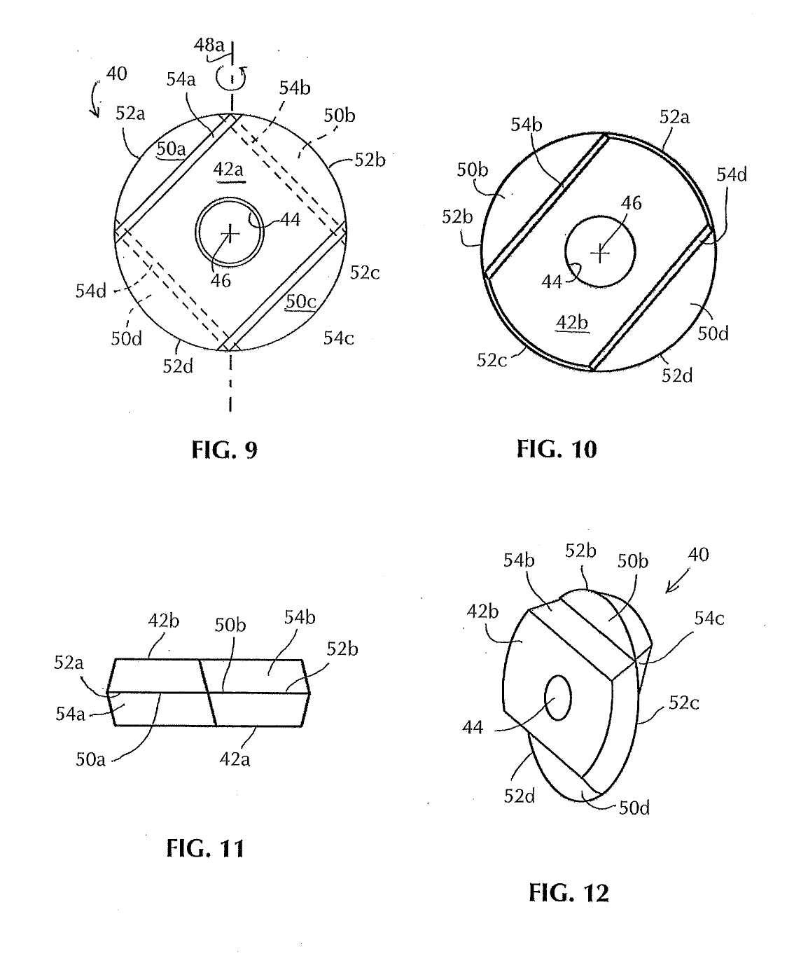

To cut a workpiece (not shown) upon rotation about the insert rotational axis 48a (FIG. 9), cutter insert 30 has two pairs of cutting surfaces and two pairs of adjacent cutting edges. One pair of cutting surfaces 50a, 50b are located at the upper end and another pair of cutting surfaces 50c, 50d are located at the lower end, as shown in FIGS. 4, 9 and 10. Each cutting surface has an associated cutting edge adjacent to it, with cutting edge 52a adjacent cutting surface 50a, cutting edge 52b adjacent cutting surface 50b, cutting edge 52c adjacent cutting surface 50c, and cutting edge 52d adjacent cutting surface 50d. In the cutting insert example shown in FIGS. 1-12, the cutting edges 52a, 52b, 52c, 52d each form substantially equal arcs of about 90° of the circular insert 40 configuration.

As shown in FIG. 3, the cutting surfaces 50a, 50b and cutting edges 52a, 52b are oriented so that the insert would cut the workpiece when rotated in a counterclockwise direction about rotational axis 48. In the cutting insert example shown in FIGS. 1-12, planar cutting surfaces 50a, 50b, 50c, 50d and adjacent cutting edges 52a, 52b, 52c, 52d, respectively, are substantially in the same plane containing the insert rotational axis 48a.

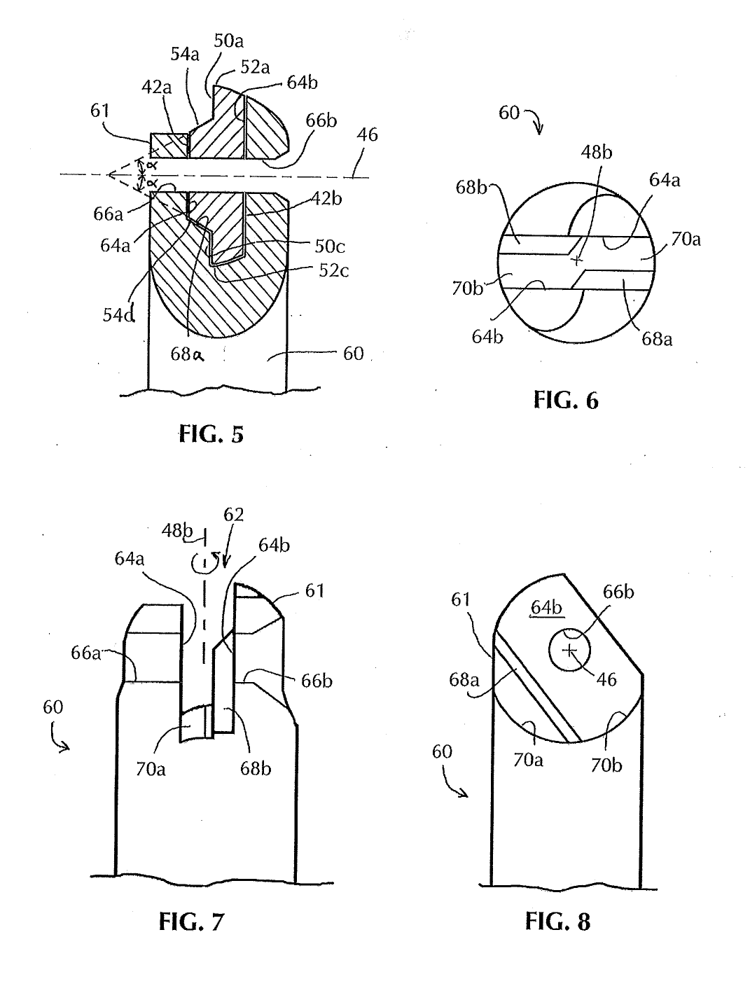

Cutter insert 30 includes a pair of planar angled locating shoulders on each side of the insert. Locating shoulders 54a, 54c form a pair on the same side as side face 42a, and locating shoulders 54b, 54d form a pair on the same side as side face 42b. When seen in side view as in FIGS. 4, 9 and 10, each locating shoulder generally is in the form of a straight chord whose ends lie on the periphery of the cutter insert at the ends of the adjacent cutting surface and edge. Each locating shoulder has an angle of about 45° with the axis of rotation 48 or 48a. Locating shoulders 54a and 54c adjacent side face 42a may lie parallel to each other on opposite sides of insert central opening 44, with their respective ends at the ends of the arcs forming cutting edges 52a and 52c, respectively. Similarly, locating shoulders 54b and 54d adjacent opposite side face 42b may lie parallel to each other on opposite sides of insert central opening 44, with their respective ends at the ends of the arcs forming cutting edges 52b and 52d, respectively. Each shoulder extends between its adjacent side face and adjacent cutting surface, so that shoulder 54a extends from side face 42a to cutting surface 50a, shoulder 54c extends from side face 42a to cutting surface 50c, shoulder 54b extends from side face 42b to cutting surface 50b and shoulder 54d extends from side face 42b to cutting surface 50d. In the side elevational views shown in FIGS. 4 and 9, the ends of locating shoulders 54a, 54b, 54c, 54d generally form a right angle with the next shoulder on the opposite side of the insert. When seen in an edge view as in FIG. 5, the plane of each locating shoulder 54a, 54b, 54c, 54d is oriented at an acute angle α to and intersects the longitudinal axis 46 of insert central opening 44. Angle α may range from about 15° to about 30°.

Cutter holder 60 comprises a spindle body rotatable about longitudinal axis 48b (FIGS. 6 and 7). When cutter insert 40 is mounted in slot 62 (FIGS. 1-4), the insert rotation axis is aligned with the holder rotation axis along axis 48. Slot 62 has spaced parallel planar inside faces 64a, 64b on opposite sides that contact the insert side faces 42a, 42b, respectively. The distance between the holder slot inside faces 64a and 64b is about the same as the thickness of the cutter insert between the insert side faces 42a and 42b, so there is a close sliding fit as the cutter insert is inserted into the holder slot. Because insert side walls 42a and 42b and holder slot inside faces 64a and 64b are flat and parallel, the cutter insert may be inserted into and removed by sliding in any direction along the slot from straight in the direction of rotational axis 48 up to about 45° on either side of the direction of rotational axis 48, as shown in FIG. 4. Slot inside faces 64a, 64b have openings 66a, 66b, respectively, aligned with insert central opening 44 and receive removable threaded fastener 32 to secure the insert within the slot.

Only one pair of insert cutting surfaces and adjacent cutting edges are used at a time to cut the workpiece. Cutting surface pair 50a, 50b and upper cutting edge pair 52a, 52b extend out of the slot 62 at holder end 61. Cutting surface 50a and cutting edge 52a are on the opposite side of axis 48a as cutting surface 50b and cutting edge 52b and face opposite directions. Cutting surface 50a and cutting edge 52a face toward side face 42a, and cutting surface 50b and cutting edge 52b face toward opposite side face 42b. The diameter of cutter holder 60 at end 61 is slightly less than the diameter or width of cuter insert 40, so that the extreme opposite ends of the cutting edges 52a, 52b extend outward from the holder end 61, and the cutter holder body does not interfere with the cutting action. As shown in FIG. 1, on each side of slot 62 end 61 is cut away 61a to expose a cutting surface and cutting edge of the cutting pair being used. When upper cutting surface pair 50a, 50b and upper cutting edge pair 52a, 52b are rotated by holder 60 about axis 48, the insert will cut a workpiece in the shape of the cutting edges 52a, 52b when the holder and insert are moved in the direction 49 of the cutting edges.

Cutting surface 50c and adjacent cutting edge 52c likewise form respective pairs with cutting surface 50d and adjacent cutting edge 52d. Cutting surface 50c and cutting edge 52c are on one side of axis 48a facing toward side face 42a, and cutting surface 50d and cutting edge 52d are on the other side of axis 48a facing toward opposite side face 42b. As shown mounted in holder 60 in FIG. 4, the pairs of lower cutting surfaces 50c, 50d and lower cutting edges 52c, 52d are disposed substantially within holder slot 62 and not in use. If the pair of cutting edges 52a, 2b become worn, fastener 32 may be removed and cutting insert 40 may be removed upward and rotated 180° about the axis 46 of opening 44 and reinserted and resecured within holder slot 62 to expose cutting surface pair 50c, 50d and cutting edge pair 52c, 52d. When fresh upper cutting surface pair 50c, 50d and upper cutting edge pair 52c, 52d are then rotated about axis 48, the insert will cut a workpiece in the shape of the cutting edges 52c, 52d when the insert is moved in the direction of the cutting edges.

To provide support and foundation for the insert within the slot during cutting, planar angled locating surfaces 68a, 68b are provided adjacent inside surfaces 64a, 64b, respectively, to contact the two of the insert locating shoulders adjacent the cutting surfaces not in use. The plane of each locating surface 68a, 68b extending from the respective adjacent inside face intersects longitudinal axis 46 of the slot central opening 44 and slot openings 66a, 66b and is oriented at the same angle α as the insert locating shoulder plane (FIG. 5). In the insert position shown in FIGS. 1-4, cutting surfaces 50c, 50d are not in use, and the respective adjacent insert locating shoulders 54c, 54d are in contact with and supported on opposite sides of slot 62 by respective locating surfaces 68a, 68b. FIGS. 4 and 5 illustrate holder locating surface 68a contacting and supporting insert shoulder 54d. (If the view of FIG. 4 were reversed, holder locating surface 68b would be in the position of surface 68a and would be supporting insert locating shoulder 54c.) In the side view of the insert and slot example shown in FIG. 4, the locating surfaces 68a, 68b each have an angle of about 45° with the axis of rotation 48 and would generally form a right angle with each other. When the cutter insert is removed and rotated 180° as described above to employ fresh cutting surfaces 50c, 50d and cutting edges 52c, 52d, insert locating shoulders 54a, 54b then contact holder locating surfaces 68a, 68b, respectively.

As shown in FIG. 4, at the bottom of slot 60 are surfaces 70a, 70b configured to provide clearance for the insert lower cutting edges 52c, 52d not in use. Clearance surfaces 70a, 70b are parallel to axis 46 and may have a complimentary shape closely conforming to the cutting edges of the cutter insert being used, in this example, arcs of a circle, and may provide a clearance of about 0.12 to about 0.25 mm (0.005 to 0.010 in.). If different types and shapes of cutter inserts are to be used in the cutter holder, the clearance surface should be configured to permit the largest of the inserts to be mounted in the slot without interference.

The entirety of the slot configuration of cutter holder 60, including all inside walls, locating surfaces and clearance surfaces, may be integrally formed of a single piece of steel or other suitable material. The surfaces within slot 60, including locating surfaces 68a, 68b and clearance surfaces 70a, 70b may be formed by electrical discharge machining (EDM). In this process, the desired shape is obtained using electrical discharges (sparks) to remove material. An electrode of desired configuration is placed near the portion of the cutter holder slot to be formed, separated by a dielectric liquid, and an electrical voltage differential is created between the electrode and holder. When the distance between the electrode and holder is reduced, the intensity of the electric field in the volume between the electrodes becomes greater than the strength of the dielectric, which breaks, allowing current to flow between the electrode and holder. As a result, material is removed from both the electrode and holder. Once the current flow stops, new liquid dielectric is usually conveyed into the inter-electrode volume enabling the solid debris particles to be carried and flushed away and the insulating properties of the dielectric to be restored. Thereafter the electrode is moved toward the holder and the difference of potential between the electrode and holder is restored to what it was before the breakdown, so that a new liquid dielectric breakdown can occur to remove more material from the holder. EDM has been found in this invention to require less removal of material from the cutter holder or body, and to remove sufficient material to properly form the locating surfaces and bottom clearance without weakening the cutter holder pocket. The ability to make the upper portion of the holder and the receiving slot as a single integral piece with close tolerances in the configuration of the present invention increases the strength of the milling tool, and provides an improvement over prior art holder designs that utilize different configurations and require multiple components to hold the cutter insert.

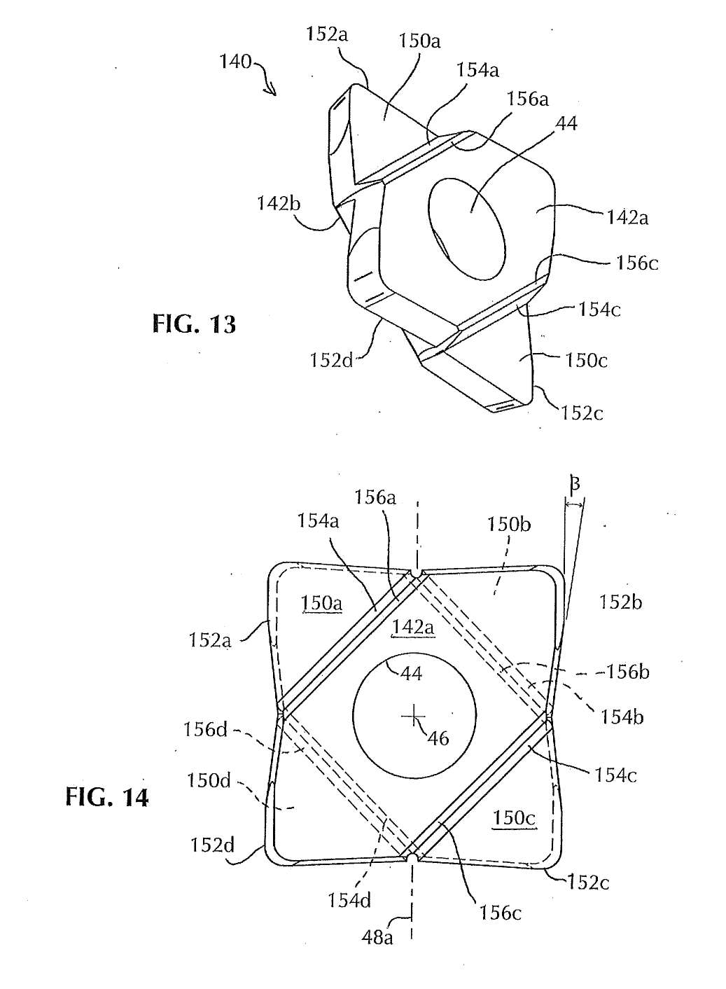

In place of the spherical ball nose cutter shown in FIGS. 1-12, other configurations of two-side cutter inserts may use the same locating shoulders to mount the cutter insert in the holder. For example, a double-sided backdraft cutter insert is shown in FIGS. 13 and 14. The backdraft cutter insert 140 structure is labeled to identify the features similar to those of the spherical ball nose cutter insert described previously, except that the numeral “1” is placed before the identifying number.

Backdraft cutter insert 140 is generally in the shape of a square with a central opening 44 extending from side face 142a to side face 142b, except that the sides of cutting edges 152a, 152b, 152c, 152d have a clearance or taper of angle β with respect to a straight line tangent to the side of the insert. Angle β is typically 7° to permit a smooth finish milling with reduced tool pressure and chatter. Cutting surfaces 150a, 150b, 150c, 150d are triangular with the hypotenuse adjacent a locating shoulder and the opposite corner angle generally rounded. As before, cutter insert 140 has 180° rotational symmetry about axes 48a and 46. As shown, the cutting surfaces are coplanar and include rotational axis 48a. The insert locating shoulders 154a, 154b, 154c, 154d are constructed in the same manner as the locating shoulders previously described, and are planar with the planes at an angle α with respect to and intersecting the axis 46 of central opening 44. Additionally, the locating shoulders 154a, 154b, 154c, 154d have beveled edges 156a, 156b, 156c, 156d, respectively, where the shoulders meet the side faces 142a or 142b.

In a manner identical to that previously described, backdraft cutter insert is secured within holder slot 62 with the pair of holder locating surfaces 68a, 68b abutted with and contacting insert locating shoulders 154c and 154d adjacent unused cutting surfaces 150c and 150d, respectively, to support the insert locating shoulder within the holder slot. In this position, insert cutting surfaces 150a, 150b and edges 152a, 152b extend out of slot 62 to cut a workpiece when the milling tool rotates the insert about rotational axis 48a. As before, lower surfaces 70a, 70b in the cutter holder slot may be configured to conform to the shape of insert cutting edge pairs 152a, 152b and 152c, 152d and provide the desired clearance. When the lower surfaces 70a, 70b are configured to conform to the cutting edges of backdraft insert cutter 140, the clearance will be sufficient to allow holder 60 to also accept double-sided ball nose insert 40.

When these cutting surfaces and edges become worn, cutter insert 140 is removed from the holder slot, rotated 180° about central opening axis 46 and re-secured within holder slot 62, this time with holder locating surfaces 68a, 68b abutted with and contacting insert locating shoulders 154a, 154b adjacent cutting surfaces 150a, 150b, respectively. This then provides sufficient support to permit fresh insert cutting surfaces 150c, 150d and edges 152c, 152d to extend out of the slot to cut the workpiece.

The present invention and method and configuration of creating the cutter holder creates a strong base against which the cutter insert can resist cutting forces, and also provides good accuracy for finish machining operations. Total indicator runout (TIR) of about 0.025 mm (0.001 in.) can be consistently maintained using this method and configuration, and results in a more stable and accurate cut.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A milling tool comprising:
a cutter insert having:
two opposite parallel planar side faces having a central opening, the central opening having a longitudinal axis passing between the side faces in a direction normal to the planes thereof, the cutter insert having an axis of rotation extending between the side faces in a direction normal to the central opening axis;
first and second pairs of cutting surfaces at opposite ends of the insert along the rotational axis, each of the pairs of cutting surfaces having a cutting edge adjacent a cutting surface, with one cutting edge in each pair of cutting surfaces being on an opposite side of the cutter axis and facing in a direction opposite the other cutting edge in the pair, each pair of cutting surfaces and adjacent cutting edges being capable of cutting a workpiece upon rotation of the cutter insert about the insert rotational axis; and
a pair of planar locating shoulders on each side of the insert, with one shoulder of a pair on one side of the central opening and the other shoulder of a pair on the other side of the central opening, each shoulder extending between the side face and an adjacent one of the cutting surfaces, the plane of each locating shoulder being at an angle to and intersecting the longitudinal axis of the insert central opening; and
a cutter holder rotatable about an axis, the cutter holder having:
a slot at one thereof containing the holder axis, the slot receiving the insert with the insert rotational axis aligned with the holder rotational axis;
the slot having opposite parallel planar inside faces contacting the insert side faces, the slot inside faces each having an opening aligned with the insert central opening for receiving a removable fastener to secure the insert within the slot, the first pair of insert cutting surfaces and edges extending out of the slot at the end of the holder and the second pair of insert cutting surfaces and edges being disposed substantially within the slot; and
the slot further having a pair of planar locating surfaces, with one locating surface extending from one of the inside faces and the other locating surface extending from the other of the inside faces, the plane of each locating surface being at the same angle as the insert locating shoulder plane and intersecting the longitudinal axis of the slot central openings, the pair of holder locating surfaces being abutted with and contacting the insert locating shoulders adjacent the second pair of cutting surfaces to support the insert locating shoulder within the holder slot and permitting the first pair of insert cutting surfaces and edges extending out of the slot to cut a workpiece when the milling tool is rotated about the rotational axis,
the cutter insert being removable from the holder slot, rotatable 180° about the central opening axis and re-securable within the holder slot with the pair of holder locating surfaces being abutted with and contacting the insert locating shoulders adjacent the first pair of cutting surfaces to support the insert locating shoulder within the holder slot and permitting the second pair of insert cutting surfaces and edges to extend out of the slot to cut a workpiece when the milling tool is rotated about the rotational axis.

2. The milling tool of claim 1 wherein the insert cutting surfaces and adjacent cutting edges are disposed in a plane containing the insert rotational axis.

3. The milling tool of claim 1 wherein the holder locating surfaces are integral with the inside faces of the holder slot.

4. The milling tool of claim 1 wherein the cutter holder slot further includes a lower surface configured to conform to the shape of the second pair of insert cutting edges.

5. The milling tool of claim 1 wherein the cutter holder slot further includes a lower surface configured to accept different cutter insert shapes without interference.

6. A milling tool cutter insert comprising:
an insert body having two opposite parallel planar side faces having a central opening, the central opening having a longitudinal axis passing between the side faces in a direction normal to the planes thereof, the cutter insert having an axis of rotation extending between the side faces in a direction normal to the central opening axis;
first and second pairs of cutting surfaces at opposite ends of the insert along the rotational axis, each of the pairs of cutting surfaces having a cutting edge adjacent a cutting surface, with one cutting edge in each pair of cutting surfaces being on an opposite side of the cutter axis and facing in a direction opposite the other cutting edge in the pair, each pair of cutting surfaces and adjacent cutting edges being capable of cutting a workpiece upon rotation of the cutter insert about the insert rotational axis; and
a pair of planar locating shoulders on each side of the insert, with one shoulder of a pair on one side of the central opening and the other shoulder of a pair on the other side of the central opening, each shoulder extending between the side face and an adjacent one of the cutting surfaces, the plane of each locating shoulder being at an angle to and intersecting the longitudinal axis of the insert central opening,
the insert locating shoulders adjacent one pair of the cutting surfaces adapted to be abutted with and contact a pair of complimentary locating surfaces in a cutter holder to support the insert within the holder and permit the other pair of the insert cutting surfaces and associated edges to cut a workpiece when the insert is rotated about the insert rotational axis.

7. The cutter insert of claim 6 wherein the insert cutting surfaces and adjacent cutting edges are disposed in a plane containing the insert rotational axis.

8. A milling tool cutter insert holder comprising:
an elongated body rotatable about a longitudinal axis;
a slot at one of the elongated body containing the rotational axis, the slot adapted to receive a cutter insert with a rotational axis of the cutter insert aligned with the holder rotational axis,
the slot having opposite parallel planar inside faces, each slot inside face having an opening alignable with a central opening in the cutter insert for receiving a removable fastener to secure the insert within the slot; and
the slot further having a pair of planar locating surfaces, with one locating surface extending from one of the inside faces and the other locating surface extending from the other of the inside faces, the plane of each locating surface being at an angle to and intersecting a longitudinal axis of the slot inside face openings, the pair of holder locating surfaces being adapted to abut and contacting a pair of complimentary locating shoulders on the cutting insert adjacent a pair of cutting surfaces on the cutting insert to support the insert locating shoulder within the holder slot and permit an opposite pair of cutting surfaces and edges on the cutting insert to cut a workpiece when the milling tool is rotated about the holder rotational axis.

9. The cutter holder of claim 8 wherein the holder locating surfaces are integral with the inside faces of the holder slot.

10. The cutter holder of claim 8 wherein the cutter holder slot further includes a lower surface configured to conform to the shape of the second pair of insert cutting edges.

11. The milling tool of claim 8 wherein the cutter holder slot further includes a lower surface configured to accept different cutter insert shapes without interference.

12. A method of using a milling tool comprising:
providing a cutter insert having two opposite parallel planar side faces with a central opening, the central opening having a longitudinal axis passing between the side faces in a direction normal to the planes thereof, the cutter insert having an axis of rotation extending between the side faces in a direction normal to the central opening axis; first and second pairs of cutting surfaces at opposite ends of the insert along the rotational axis, each of the pairs of cutting surfaces having a cutting edge adjacent a cutting surface, with one cutting edge in each pair of cutting surfaces being on an opposite side of the cutter axis and facing in a direction opposite the other cutting edge in the pair; and a pair of planar locating shoulders on each side of the insert, with one shoulder of a pair on one side of the central opening and the other shoulder of a pair on the other side of the central opening, each shoulder extending between the side face and an adjacent one of the cutting surfaces, the plane of each locating shoulder being at an angle to and intersecting the longitudinal axis of the insert central opening;
providing a cutter holder rotatable about an axis, the cutter holder having a slot at one thereof containing the holder axis, the slot adapted to receive the insert with the insert rotational axis aligned with the holder rotational axis, the slot having opposite parallel planar inside faces, the slot inside faces each having an opening alignable with the insert central opening for receiving a removable fastener to secure the insert within the slot, the slot further having a pair of planar locating surfaces, with one locating surface extending from one of the inside faces and the other locating surface extending from the other of the inside faces, the plane of each locating surface being at the same angle as the insert locating shoulder plane and intersecting the longitudinal axis of the slot central openings;
securing the cutter insert in the holder slot with the pair of holder locating surfaces being abutted with and contacting the insert locating shoulders adjacent the second pair of cutting surfaces so that the first pair of insert cutting surfaces and edges extend out of the slot;
rotating the milling tool about the rotational axis and cutting a workpiece with the first pair of cutting edges;
removing the cutter insert from the holder slot;
rotating the cutter insert 180° about the central opening axis;
securing the cutter insert in the holder slot with the pair of holder locating surfaces being abutted with and contacting the insert locating shoulders adjacent the first pair of cutting surfaces so that the second pair of insert cutting surfaces and edges extend out of the slot; and
rotating the milling tool about the rotational axis and cutting a workpiece with the second pair of cutting edges.
